(19) United States
(12) Patent Application Publication
(10) Pub. No.: US 2026/0195064 A1
(43) Pub. Date: Jul. 9, 2026

(54) OPTIMIZING TEMPORARY SPACES IN A COMPUTER SYSTEM

(71) Applicant: International Business Machines Corporation, Armonk, NY (US)

(72) Inventors: Hui Wang, Beijing (CN); Xiang Yu Xue, Rizhao (CN); Yu Mei Dai, Beijing (CN); Peng Hui Jiang, Beijing (CN); Mai Zeng, Beijing (CN); Xiao Chen Huang, Beijing (CN); Wei Li, Beijing (CN)

(21) Appl. No.: 19/009,205

(22) Filed: Jan. 3, 2025

(51) Int. Cl. G06F 3/06

(52) U.S. Cl. CPC G06F 3/0644; G06F 3/0604; G06F 3/0631; G06F 3/067

(57) ABSTRACT

A computer-implemented method for managing temporary spaces in a computer system. A processor set analyzes historical data for a number of applications to determine a temporary space usage for the number of applications. The processor set assigns labels to a number of temporary folders within the computer system. The labels for the number of temporary folders are determined based on attributes associated with the number of applications. The processor set trains a number of machine learning models based on the temporary spaces usage and information associated with the number of temporary folders. The processor set determines future temporary space usage for the number of applications using the machine learning models. The processor set reserves a portion of the temporary spaces in the computer system based on the future temporary space usage.

### BACKGROUND

The disclosure relates generally to temporary spaces in a computer system.

Temporary spaces in computer systems are storage areas designated to hold data or files for a limited period of time, especially while the data are actively in use or temporarily needed by the system or specific applications. These spaces can be found on a computer's hard drive, solid state drive (SSD), or within random access memory (RAM) and include areas such as temporary folders, cache directories, and swap spaces. For example, browser caches are temporary spaces for storing website images and resources to enable faster loading.

Temporary spaces play a foundational role in the smooth functioning of computer systems and applications, especially as systems grow more complex and data intensive. The temporary spaces enable a more organized and streamlined approach to manage data for maintaining optimal performance across various tasks. In addition, temporary spaces contribute to security and data recovery. By temporarily storing files in encrypted formats or secure locations, unauthorized access to sensitive information can be prevented.

In summary, temporary spaces are vital components for computer systems to efficiently handle tasks, manage memories, and protect user data. The ability of temporary spaces to enhance system flexibility, data processing, and security makes them indispensable in both personal computing and large-scale enterprise environments.

### SUMMARY

According to one illustrative embodiment, a computer-implemented method for managing temporary spaces in a computer system is provided. A processor set analyzes historical data for a number of applications to determine a temporary space usage for the number of applications. The processor set assigns labels to a number of temporary folders within the computer system. The labels for the number of temporary folders are determined based on attributes associated with the number of applications. The processor set trains a number of machine learning models based on the temporary spaces usage and information associated with the number of temporary folders. The processor set determines future temporary space usage for the number of applications using the machine learning models. The processor set reserves a portion of the temporary spaces as reserved spaces in the computer system based on the future temporary space usage. According to other illustrative embodiments, a computer system, and a computer program product for managing temporary spaces in a computer system are provided.

### BRIEF DESCRIPTION OF THE DRAWINGS

FIG. 1 is a pictorial representation of a computing environment in which illustrative embodiments may be implemented;

FIG. 2 is an illustration of a block diagram of a temporary space management environment in accordance with an illustrative embodiment;

FIG. 3 is an illustration of a data structure for storing labels for temporary folders and information associated with temporary folders in accordance with an illustrative embodiment;

FIG. 4 is a flowchart of a process for managing temporary spaces in a computer system in accordance with an illustrative embodiment;

FIG. 5 is a flowchart of a process for reserving temporary spaces in accordance with an illustrative embodiment;

FIG. 6 is a flowchart of a process for allocating temporary spaces in accordance with an illustrative embodiment;

FIG. 7 is a block diagram of a data processing system in accordance with an illustrative embodiment.

### DETAILED DESCRIPTION

A computer implemented method manages temporary spaces in a computer system. A processor set analyzes historical data for a number of applications to determine a temporary space usage for the number of applications. The processor set assigns labels to a number of temporary folders within the computer system. The labels for the number of temporary folders are determined based on attributes associated with the number of applications. The processor set trains a number of machine learning models based on the temporary spaces usage and information associated with the number of temporary folders. The processor set determines future temporary space usage for the number of applications using the machine learning models. The processor set reserves a portion of the temporary spaces as reserved spaces in the computer system based on the future temporary space usage. As a result, the illustrative embodiments provide a technical effect of reserving temporary spaces in the computer system for important applications based on temporary space usage predicted for the important applications.

In the illustrative embodiments, as part of reserving the portion of the temporary spaces as the reserved spaces in the computer system based on the future temporary space usage, the processor set divides the temporary spaces in the computer system into the reserved spaces and free spaces based on the future temporary space usage. The processor set divides the reserved spaces into a number of first segments and the free spaces into a number of second segments. Each segment from the number of first segments and the number of second segments represents a temporary folder from the number of temporary folders. As a result, the illustrative embodiments provide a technical effect of separating temporary spaces reserved for important applications and temporary spaces for other applications such that temporary spaces in the computer system can be efficiently managed and utilized.

In the illustrative embodiments, the processor set receives a request for allocating temporary spaces for a first application in the number of applications. The processor set determines whether an importance score for the first application exceeds a predefined threshold. In response to determining that the importance score for the first application exceeds a predefined threshold, the processor set allocates a first segment from the number of first segments for the reserved spaces to the first application. As a result, the illustrative embodiments provide a technical effect of allocating reserved temporary spaces for applications that are deemed to be important such that temporary spaces in the computer system can be efficiently managed and utilized.

In the illustrative embodiments, in response to determining that the importance score for the first application does not exceed a predefined threshold, the processor set allocates a second segment from the number of second segments for the free spaces to the first application. As a result, the illustrative embodiments provide a technical effect of allocating free temporary spaces that are not reserved spaces for applications that are deemed to be not important such that temporary spaces in the computer system can be efficiently managed and utilized.

In the illustrative embodiments, the second segment from the number of second segments is determined by matching attributes for the first application to labels for each temporary folder represented by a segment from the number of second segments. As a result, the illustrative embodiments provide a technical effect of efficiently identifying most suitable temporary folders for the application requesting temporary spaces such that temporary spaces in the computer system can be efficiently managed and utilized.

In the illustrative embodiments, temporary spaces requested by the first application are allocated for a period of time based on life cycle of the first application. As a result, the illustrative embodiments provide a technical effect of allocating requested temporary spaces to the applications for a limited period of time when the applications need those temporary spaces, thereby achieving efficient management and utilization of temporary spaces in the computer system.

In the illustrative embodiments, the labels for the number of temporary folders comprise sizes of temporary spaces, identifiers for the number of applications, location of temporary spaces, and lifecycles for the number of applications. As a result, the illustrative embodiments provide a technical effect of using most relevant attributes for the applications for making labels for temporary folders in temporary spaces.

A computer system comprises a processor set, a set of one or more computer-readable storage media, and program instructions, stored in the set of one or more computer-readable storage media, to cause the processor set to perform the following computer operations. The processor set analyzes historical data for a number of applications to determine a temporary space usage for the number of applications. The processor set assigns labels to a number of temporary folders within the computer system. The labels for the number of temporary folders are determined based on attributes associated with the number of applications. The processor set trains a number of machine learning models based on the temporary spaces usage and information associated with the number of temporary folders. The processor set determines future temporary space usage for the number of applications using the machine learning models. The processor set reserves a portion of the temporary spaces as reserved spaces in the computer system based on the future temporary space usage. As a result, the illustrative embodiments provide a technical effect of reserving temporary spaces in computer system for important applications based on temporary space usage predicted for the important applications.

In the illustrative embodiments, as part of reserving the portion of the temporary spaces as the reserved spaces in the computer system based on the future temporary space usage, the processor set further executes the program instructions to divide the temporary spaces in the computer system into reserved spaces and free spaces based on the future temporary space usage. The processor set further executes the program instructions to divide the reserved spaces into a number of first segments and the free spaces into a number of second segments. Each segment from the number of first segments and the number of second segments represents a temporary folder from the number of temporary folders. As a result, the illustrative embodiments provide a technical effect of separating temporary spaces reserved for important applications and temporary spaces for other applications such that temporary spaces in the computer system can be efficiently managed and utilized.

In the illustrative embodiments, the processor set further executes the program instructions to receive a request for allocating temporary spaces for a first application in the number of applications. The processor set further executes the program instructions to determine whether an importance score for the first application exceeds a predefined threshold. In response to determining that the importance score for the first application exceeds a predefined threshold, the processor set further executes the program instructions to allocate a first segment from the number of first segments for the reserved spaces to the first application. As a result, the illustrative embodiments provide a technical effect of allocating reserved temporary spaces for applications that are deemed to be important such that temporary spaces in the computer system can be efficiently managed and utilized.

In the illustrative embodiments, in response to determining that the importance score for the first application does not exceed a predefined threshold, the processor set further executes the program instructions allocate a second segment from the number of second segments for the free spaces to the first application. As a result, the illustrative embodiments provide a technical effect of allocating free temporary spaces that are not reserved spaces for applications that are deemed to be not important such that temporary spaces in the computer system can be efficiently managed and utilized.

In the illustrative embodiments, the second segment from the number of second segments is determined by matching attributes for the first application to labels for each temporary folder represented by a segment from the number of second segments. As a result, the illustrative embodiments provide a technical effect of efficiently identifying most suitable temporary folders for the application requesting temporary spaces such that temporary spaces in the computer system can be efficiently managed and utilized.

In the illustrative embodiments, temporary spaces requested by the first application are allocated for a period of time based on the life cycle of the first application. As a result, the illustrative embodiments provide a technical effect of allocating requested temporary spaces to the applications for a limited period of time when the applications need those temporary spaces, thereby achieving efficient management and utilization of temporary spaces in the computer system.

In the illustrative embodiments, the labels for the number of temporary folders comprise sizes of temporary spaces, identifiers for the number of applications, location of temporary spaces, and lifecycles for the number of applications. As a result, the illustrative embodiments provide a technical effect of using the most relevant attributes for the applications for making labels for temporary folders in temporary spaces.

In the illustrative embodiments, a computer program product manages temporary spaces in a computer system. The computer program product comprises a set of one or more computer-readable storage media and program instructions, stored in the set of one or more computer-readable storage media, for causing a processor set to perform the following computer operations. The program instructions are executable by a computer system to analyze historical data for a number of applications to determine a temporary space usage for the number of applications. The program instructions are executable by the computer system to cause the computer system to assign labels to a number of temporary folders within the computer system. The labels for the number of temporary folders are determined based on attributes associated with the number of applications. The program instructions are executable by the computer system to cause the computer system to train a number of machine learning models based on the temporary spaces usage and information associated with the number of temporary folders. The program instructions are executable by the computer system to cause the computer system to determine future temporary space usage for the number of applications using the machine learning models. The program instructions are executable by the computer system to cause the computer system to reserve a portion of the temporary spaces as reserved spaces in the computer system based on the future temporary space usage. As a result, the illustrative embodiments provide a technical effect of reserving temporary spaces in the computer system for important applications based on temporary space usage predicted for the important applications.

In the illustrative embodiments, as part of reserving the portion of the temporary spaces as the reserved spaces in the computer system based on the future temporary space usage, the program instructions are further executable by the computer system to cause the computer system to divide the temporary spaces in the computer system into reserved spaces and free spaces based on the future temporary space usage. The program instructions are further executable by the computer system to cause the computer system to divide the reserved spaces into a number of first segments and the free spaces into a number of second segments. Each segment from the number of first segments and the number of second segments represents a temporary folder from the number of temporary folders. As a result, the illustrative embodiments provide a technical effect of separating temporary spaces reserved for important applications and temporary spaces for other applications such that temporary spaces in the computer system can be efficiently managed and utilized.

In the illustrative embodiments, the program instructions are further executable by the computer system to cause the computer system to receive a request for allocating temporary spaces for a first application in the number of applications. The program instructions are further executable by the computer system to cause the computer system to determine whether an importance score for the first application exceeds a predefined threshold. In response to determining that the importance score for the first application exceeds a predefined threshold, the program instructions are further executable by the computer system to cause the computer system to allocate a first segment from the number of first segments for the reserved spaces to the first application. As a result, the illustrative embodiments provide a technical effect of allocating reserved temporary spaces for applications that are deemed to be important such that temporary spaces in the computer system can be efficiently managed and utilized.

In the illustrative embodiments, in response to determining that the importance score for the first application does not exceed a predefined threshold, the program instructions are further executable by the computer system to cause the computer system to allocate a second segment from the number of second segments for the free spaces to the first application. As a result, the illustrative embodiments provide a technical effect of allocating free temporary spaces that are not reserved spaces for applications that are deemed to be not important such that temporary spaces in the computer system can be efficiently managed and utilized.

In the illustrative embodiments, the second segment from the number of second segments is determined by matching attributes for the first application to labels for each temporary folder represented by a segment from the number of second segments. As a result, the illustrative embodiments provide a technical effect of efficiently identifying most suitable temporary folders for the application requesting temporary spaces such that temporary spaces in the computer system can be efficiently managed and utilized.

In the illustrative embodiments, temporary spaces requested by the first application are allocated for a period of time based on the life cycle of the first application. As a result, the illustrative embodiments provide a technical effect of allocating requested temporary spaces to the applications for a limited period of time when the applications need those temporary spaces, thereby achieving efficient management and utilization of temporary spaces in the computer system.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one or more storage media (also called “mediums”) collectively included in a set of one or more storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

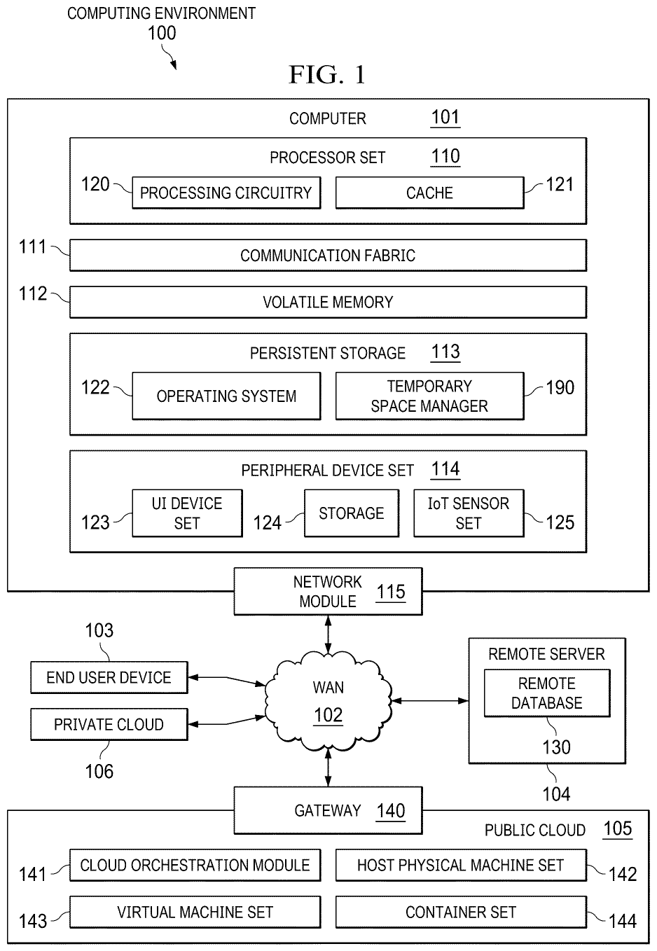

With reference now to the figures, and in particular with reference to FIG. 1, a block diagram of a computing environment is depicted in accordance with an illustrative embodiment. Computing environment 100 contains an example of an environment for the execution of at least some of the computer code involved in performing the inventive methods, such as temporary space manager 190. In addition to temporary space manager 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and temporary space manager 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one or more computer processors of any type now known or to be developed in the future. Processing circuitry 120 may be distributed over multiple packages, for example, multiple coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions and associated data are accessed by processor set 110 to control and direct performance of the inventive methods. In computing environment 100, at least some of the instructions for performing the inventive methods may be stored in temporary space manager 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, volatile memory 112 is located in a single package and is internal to computer 101, but, alternatively or additionally, volatile memory 112 may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in temporary space manager 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as a thin client, heavy client, mainframe computer, desktop computer, and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data application portability between the multiple constituent clouds. In this embodiment, public cloud 105 and private cloud 106 are both part of a larger hybrid cloud.

CLOUD COMPUTING SERVICES AND/OR MICROSERVICES: Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (Saas) where software is centrally hosted and allocated on a subscription basis. SaaS is also known as on-demand software, web-based software, or web-hosted software. Four technological sub-fields involved in cloud services are: deployment, integration, on demand, and virtual private networks.

The illustrative embodiments recognize and take into account one or more different considerations as described herein. For example, the illustrative embodiments recognize and take into account that due to the lack of a unified management mechanism, the storage space and cleaning strategy of temporary files may become disorganized and difficult to manage and maintain.

The illustrative embodiments also recognize and take into account that the existing technique of storing all temporary files in the same directory may result in insufficient flexibility in the utilization of temporary spaces, making it difficult to effectively manage and allocate temporary spaces according to actual needs.

In addition, the illustrative embodiments also recognize and take into account that existing cleaning strategies often lack rationality, which may lead to important data being mistakenly deleted.

Thus, illustrative embodiments of the present invention provide a computer implemented method, computer system, and computer program product for managing temporary spaces in a computer system. A processor set analyzes historical data for a number of applications to determine a temporary space usage for the number of applications. The processor set assigns labels to a number of temporary folders within the computer system. The labels for the number of temporary folders are determined based on attributes associated with the number of applications. The processor set trains a number of machine learning models based on the temporary spaces usage and information associated with the number of temporary folders. The processor set determines future temporary space usage for the number of applications using the machine learning models. The processor set reserves a portion of the temporary spaces in the computer system based on the future temporary space usage.

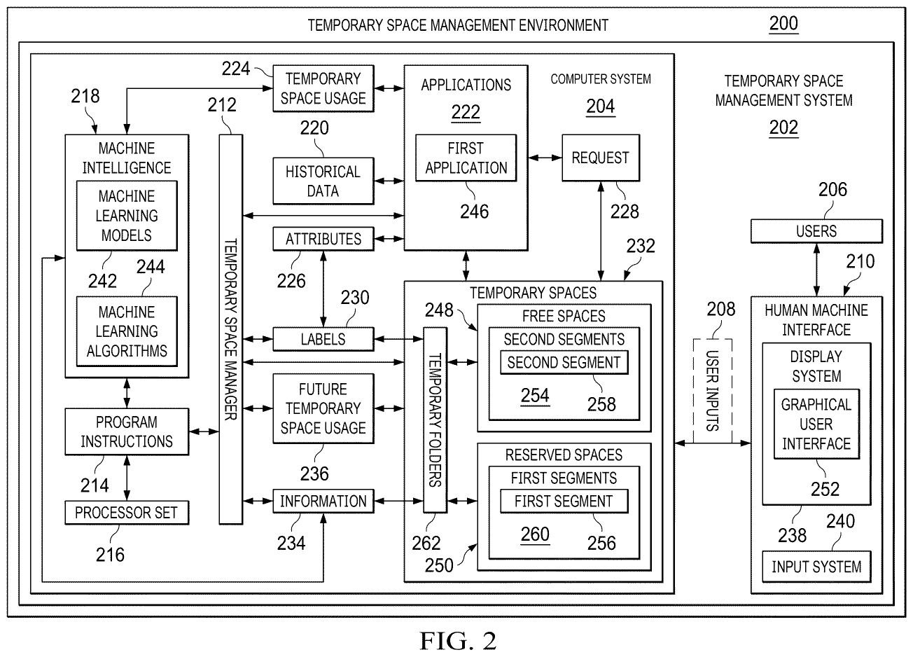

With reference now to FIG. 2, an illustration of a block diagram of a temporary space management environment is depicted in accordance with an illustrative embodiment. In this illustrative example, temporary space management environment 200 includes components that can be implemented in hardware such as the hardware shown in computing environment 100 in FIG. 1.

In this illustrative example, temporary space management system 202 in temporary space management environment 200 can be used for managing temporary spaces 232 in computer system 204. In this illustrative example, temporary spaces 232 are designed areas of storage that can be used for storing data or files for a limited period of time while the data or files are actively used by applications such as applications 222 in computer system 204. In this illustrative example, temporary space management system 202 includes computer system 204 which includes temporary space manager 212. Temporary space manager 212 is located in computer system 204. Temporary space manager 212 may be implemented using temporary space manager 190 in FIG. 1.

Temporary space manager 212 can be implemented in software, hardware, firmware, or a combination thereof. When software is used, the operations performed by temporary space manager 212 can be implemented in program instructions configured to run on hardware, such as a processor unit. When firmware is used, the operations performed by temporary space manager 212 can be implemented in program instructions and data and stored in persistent memory to run on a processor unit. When hardware is employed, the hardware can include circuits that operate to perform the operations in temporary space manager 212.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations” is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C,” may include item A, item A and item B, or item B. This example also may include item A, item B, and item C, or item B and item C. Of course, any combination of these items can be present. In some illustrative examples, “at least one of” can be, for example, without limitation, two of item A; one of item B; and ten of item C; four of item B and seven of item C; or other suitable combinations.

Computer system 204 is a physical hardware system and includes one or more data processing systems. When more than one data processing system is present in computer system 204, those data processing systems are in communication with each other using a communications medium. The communications medium can be a network. The data processing systems can be selected from at least one of a computer, a server computer, a tablet computer, or some other suitable data processing system.

As depicted, computer system 204 includes processor set 216 that is capable of executing program instructions 214 implementing processes in the illustrative examples. In other words, program instructions 214 are computer-readable program instructions.

As used herein, a processor unit in processor set 216 is a hardware device and is comprised of hardware circuits such as those on an integrated circuit that respond to and process instructions and program code that operate a computer. A processor unit can be implemented using processor set 110 in FIG. 1. When processor set 216 executes program instructions 214 for a process, processor set 216 can be one or more processor units that are in the same computer or in different computers. In other words, the process can be distributed between processor set 216 on the same or different computers in computer system 204.

Further, processor set 216 can be of the same type or different types of processor units. For example, processor set 216 can be selected from at least one of a single core processor, a dual-core processor, a multi-processor core, a general-purpose central processing unit (CPU), a graphics processing unit (GPU), a digital signal processor (DSP), or some other type of processor unit.

As depicted, computer system 204 includes machine intelligence 218. Machine intelligence 218 can include machine learning models 242 and machine learning algorithms 244. Machine learning models 242 is a branch of artificial intelligence (AI) that enables computers to detect patterns and improve performance without direct programming commands. Rather than relying on direct input commands to complete a task, machine learning models 242 relies on input data. The data is fed into the machine, one of machine learning algorithms 244 is selected, parameters for the data are configured, and the machine is instructed to find patterns in the input data through optimization algorithms. The data model formed from analyzing the data is then used to predict future values.

Machine intelligence 218 is continuously refined over time through trial and error. Equivalence of assets or products can be effectively performed by supervised machine learning, unsupervised machine learning, or semi-supervised machine learning so that products or assets that do not match descriptively can nevertheless be matched. Over time, the data model from machine learning can provide a greater degree of flexibility in matching machine intelligence 218.

Machine intelligence 218 can be implemented using one or more systems such as an artificial intelligence system, a neural network, a generative neural network, a Bayesian network, an expert system, a fuzzy logic system, a genetic algorithm, or other suitable types of systems. Machine learning models 242 and machine learning algorithms 244 may make computer system 204 a special purpose computer for predicting usage of temporary spaces 232 and efficiently managing temporary spaces 232 based on a predicted usage of temporary spaces 232.

Machine learning models 242 involves using machine learning algorithms 244 to build computation models based on samples of data. The samples of data used for training are referred to as training data or training datasets. Machine intelligence 218 can make predictions without being explicitly programmed to make these predictions. Machine intelligence 218 can be used for training and retraining computation models for a number of different types of applications. These applications include, for example, medicine, financial services, healthcare, speech recognition, computer vision, or other types of applications.

In this illustrative example, machine learning algorithms 244 can include supervised machine learning algorithms and unsupervised machine learning algorithms. Supervised machine learning can train machine learning models using data containing both the inputs and desired outputs. Examples of machine learning algorithms include Gradient Boosting algorithm, Autogressive Integrated Moving AVERAGE (ARIMA), XGBoost, K-means clustering, and Random Forest algorithm.

In this illustrative example, machine learning models 242 can be retrained or updated using new data or outputs generated by machine learning models 242 such that parameters in machine learning algorithms selected for machine learning models 242 can be adjusted to improve accuracy and efficiency of machine learning models 242.

As depicted, computer system 204 includes temporary spaces 232 for storing temporary files for applications 222. In this illustrative example, applications 222 are software programs that are designed to perform specific tasks or functions. Temporary spaces 232 include temporary folders 262, which are directories within temporary spaces 232 that are used to store files needed only for short-term purposes during system operations or application processes.

In this illustrative example, temporary space manager 212 can analyze historical data 220 for applications 222. Historical data 220 includes records and logs of past activities, performance metrics, and usage patterns related to applications 222. In other words, historical data 220 for applications 222 can provide information associated with usage of temporary spaces 232 during operations for applications 222. As a result, temporary space manager 212 can generate temporary space usage 224 by analyzing historical data 220 for applications 222. In other words, temporary space usage 224 provides information related to how temporary spaces 232 are managed and utilized during operations for applications 222.

In this illustrative example, temporary space manager 212 can further assign labels 230 to temporary folders 262. Labels 230 are determined based on attributes 226 for applications 222. In this illustrative example, attributes 226 are characteristics, behaviors, and metrics that define how an application from applications 222 performs and functions during operations. In this illustrative example, labels 230 that are determined based on attributes 226 can include sizes of temporary spaces used by applications 222, identifiers for applications 222, locations of applications 222, locations of temporary spaces allocated to temporary spaces, lifecycles of applications 222, and any suitable information related to the operations for applications 222.

Temporary space manager 212 can train machine learning models 242 using temporary space usage 224 and information 234 for temporary folders 262. In this illustrative example, information 234 and labels 230 can be stored in a data structure for organization and fast retrieval. In this illustrative example, information 234 can include file metadata such as file names, file sizes and file types, system and application data such as session data, log files, and configuration files, intermediary and processing data such as rendering files and compressed data, expiry and cleanup information such as retention duration, lifecycle of applications, clean policies, usage patterns, or any suitable information associated with temporary folders 262. As a result, machine learning models 242 can identify usage patterns of temporary spaces 232 for applications 222 and recognize how temporary spaces 232 is utilized and managed during operations for applications 222.

In this illustrative example, temporary space manager 212 uses machine learning models 242 to determine future temporary space usage 236 for applications 222 in computer system 204. Future temporary space usage 236 is a prediction for the amount of temporary space that applications 222 will require during operations over time. In this illustrative example, temporary space manager 212 can reserve a portion of temporary spaces 232 as reserved spaces 250 based on future temporary space usage 236.

Reserved spaces 250 are storage spaces in temporary spaces 232 that are reserved for important applications in applications 222. In this illustrative example, each application in applications 222 can be assigned with an importance score based on characteristics and operations for the application. Importance scores for applications 222 can be determined in a number of ways. For example, importance scores for applications 222 can be determined based on a number of weighted metrics such as frequency of use, peak usage times, system dependencies, integration levels, resource consumption, downtime impact, error tolerance, or any information associated with operations for applications 222. In this illustrative example, applications with importance scores that exceed a pre-defined threshold can be considered as important applications in applications 222. In an alternative example, a portion of applications 222 can be manually determined as important applications or automatically determined by temporary space manager 212 through training machine learning models 242 to identify important applications from applications 222.

As depicted, temporary spaces 232 can be divided into free spaces 248 and reserved spaces 250. In this illustrative example, reserved spaces 250 can be divided into first segments 256 and free spaces 248 can be divided into second segments 254. Each segment in first segments 256 and second segments 254 represents a temporary folder from temporary folders 262. In other words, each segment in first segments 256 and second segments 254 corresponds to a portion of storage space encompassed by a temporary folder in temporary spaces 232.

In this illustrative example, reserved spaces 250 are storage spaces in temporary spaces 232 that are pre-allocated to important applications in applications 222 while free spaces 248 are storage spaces that can be used for all other applications in applications 222. In other words, applications that are deemed to be not important among applications 222 will not be allocated with storage space from reserved spaces 250.

For example, first application 246 from applications 222 can send request 228 for requesting temporary storage space from temporary spaces 232 for operations. In this illustrative example, temporary space manager 212 determines whether the importance score for first application 246 exceeds a pre-defined threshold. If the importance score for first application 246 exceeds the pre-defined threshold, temporary space manager 212 can allocate first segment 260 from reserved spaces 250 to first application 246. On the other hand, if the importance score for first application 246 does not exceed the pre-defined threshold, temporary space manager 212 can allocate second segment 258 from free spaces 248 to first application 246.

In this illustrative example, the determination of first segment 260 and second segment 258 can be performed by matching attributes for first application 246 to labels for each temporary folder in temporary folders 262 that is represented by a segment from second segments 254 and first segments 256. In other words, first segment 260 and second segment 258 represent temporary folders that are assigned to provide temporary spaces for applications that have similar attributes as first application 246.

For example, if first application 246 has an attribute of “long-term” for lifecycle and an attribute of “5” for size of temporary space requested, temporary space manager 212 will allocate a segment from free spaces 248 and reserved spaces 250 that also has a label of “long-term” for lifecycle and a label of “5” for size of temporary space requested. In another example, if first application 246 has an attribute of “long-term” for lifecycle, an importance score of “1”, where an importance score of “1” is the highest importance level, and an attribute of “5” for size of temporary space requested, temporary space manager 212 will only allocate a segment from reserved spaces 250 that also has label of “long-term” for lifecycle, a label of “1” for importance score, and a label of “5” for size of temporary space requested.

In this illustrative example, it should be understood that first segment 260 or second segment 258 is allocated to first application 246 for a limited period of time determined based on lifecycle for first application 246. In this illustrative example, temporary space manager can clean first segment 260 or second segment 258 based on a label of clean policies after first application 246 is terminated.

In this illustrative example, users 206 can interact with computer system 204 through user inputs to computer system 204. For example, computer system 204 can receive user inputs 208 that includes selection of important applications from applications 222.

In this illustrative example, user inputs 208 can be generated by users 206 using human machine interface (HMI) 210. As depicted, human machine interface 210 includes display system 238 and input system 240. Display system 238 is a physical hardware system and includes one or more display devices on which graphical user interface 252 can be displayed. The display devices can include at least one of a light emitting diode (LED) display, an organic light emitting diode (OLED) display, a computer monitor, a projector, a flat panel display, a heads-up display (HUD), a head-mounted display (HMD), smart glasses, augmented reality glasses, or some other suitable device that can output information for the visual presentation of information.

In this example, users 206 are people that can interact with graphical user interface 252 through user inputs 208 generated by input system 240. Input system 240 is a physical hardware system and can be selected from at least one of a mouse, a keyboard, a touch pad, a trackball, a touchscreen, a stylus, a motion sensing input device, a gesture detection device, a data glove, a cyber glove, a haptic feedback device, or some other suitable type of input device. For example, users 206 can view temporary space usage 224 attributes 226, labels 230, temporary folders 262, future temporary space usage 236, divisions of free spaces 248 and reserved spaces 250 through graphical user interface 252.

In one illustrative example, one or more solutions are present that overcome a problem with managing temporary spaces in a computer system. As a result, one or more technical solutions may provide an ability to increase the efficiency and performance in computer system 204 by optimizing temporary spaces utilization by assigning most appropriate temporary folders in temporary spaces to applications according to the attributes for applications.

In the illustrative example, computer system 204 can be configured to perform at least one of the steps, operations, or actions described in the different illustrative examples using software, hardware, firmware, or a combination thereof. As a result, computer system 204 operates as a special purpose computer system in which temporary space manager 212 in computer system 204 enables management of temporary spaces in a computer system in an efficient manner. In particular, temporary space manager 212 transforms computer system 204 into a special purpose computer system as compared to currently available general computer systems that do not have temporary space manager 212.

In the illustrative example, the use of temporary space manager 212 in computer system 204 integrates processes into a practical application for managing temporary spaces in a computer system. In other words, temporary space manager 212 in computer system 204 is directed to a practical application of processes integrated into temporary space manager 212 in computer system 204 that supports management of temporary spaces. In this illustrative example, temporary space manager 212 can efficiently help computer system 204 to increase computer performance and avoid wasting computing resources because efficient management and utilization of temporary spaces in a computer system provide significant technical advantages.

The illustration of temporary space management environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, temporary spaces 232 can further have a portion of storage spaces for applications that are running in computer system 204 in addition to free spaces 248 and reserved spaces 250. In another example, temporary space manager 212 can also be used for allocating storage space from temporary spaces 232 to an application that does not belong to applications 222. In this example, temporary space manager 212 can use machine learning models 242 to identify a portion of temporary spaces for allocation based on attributes for the application requesting temporary spaces.

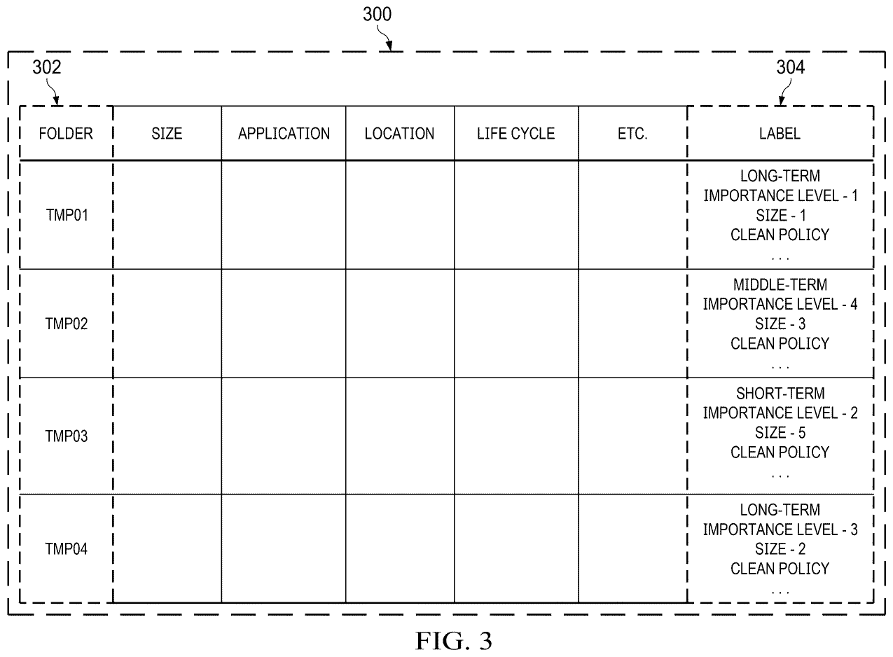

With reference now to FIG. 3, an illustration of a data structure for storing labels for temporary folders and information associated with temporary folders is shown in accordance with an illustrative embodiment. In this illustrative example, table 300 can be an example of data structure for storing information 234 and labels 230 in FIG. 2.

In this illustrative example, table 300 includes a number of columns that store information for temporary space usage by applications. For example, column 302 shows name of temporary folders and column 304 shows labels created for each temporary folder. In this illustrative example, temporary folders shown in column 302 can be examples of temporary folders 262 in FIG. 2 and labels shown in column 304 can be examples of labels 230 in FIG. 2.

As depicted, labels in column 304 are determined and created based on attributes associated with applications that utilize temporary spaces corresponding to the temporary folders shown in column 302. In FIG. 3, labels in column 304 include life cycle of applications, importance scores for applications, size of temporary spaces requested by applications, and clean policies for temporary folders. In this illustrative example, table 300 can be used for organizing information associated with utilization of temporary folders in temporary spaces, thereby improving the efficiency of temporary space utilization in a computer system.

The illustration of table 300 in FIG. 3 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, table 300 can include more columns that include other information associated with temporary folders in temporary spaces and utilization of these temporary folders by applications.

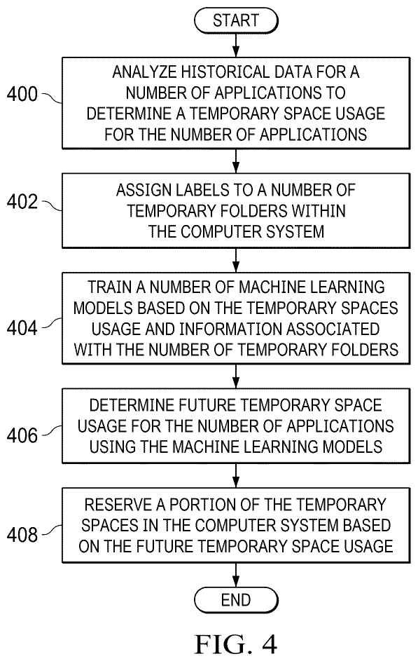

With reference now to FIG. 4, a flowchart illustrating a process for managing temporary spaces in a computer system is shown in accordance with an illustrative embodiment. The process in FIG. 4 can be implemented in hardware, software, or both. When implemented in software, the process can take the form of program instructions that are run by one of more processor units located in one or more hardware devices in one or more computer systems. For example, the process can be implemented in temporary space manager 212 in computer system 204 in FIG. 2.

The process begins by analyzing historical data for a number of applications to determine a temporary space usage for the number of applications (step 400). The process assigns labels to a number of temporary folders within the computer system (step 402). In step 402, the labels for the number of temporary folders are determined based on attributes associated with the number of applications.

The process trains a number of machine learning models based on the temporary spaces usage and information associated with the number of temporary folders (step 404). The process determines future temporary space usage for the number of applications using the machine learning models (step 406). The process reserves a portion of the temporary spaces in the computer system based on the future temporary space usage (step 408). The process terminates thereafter.

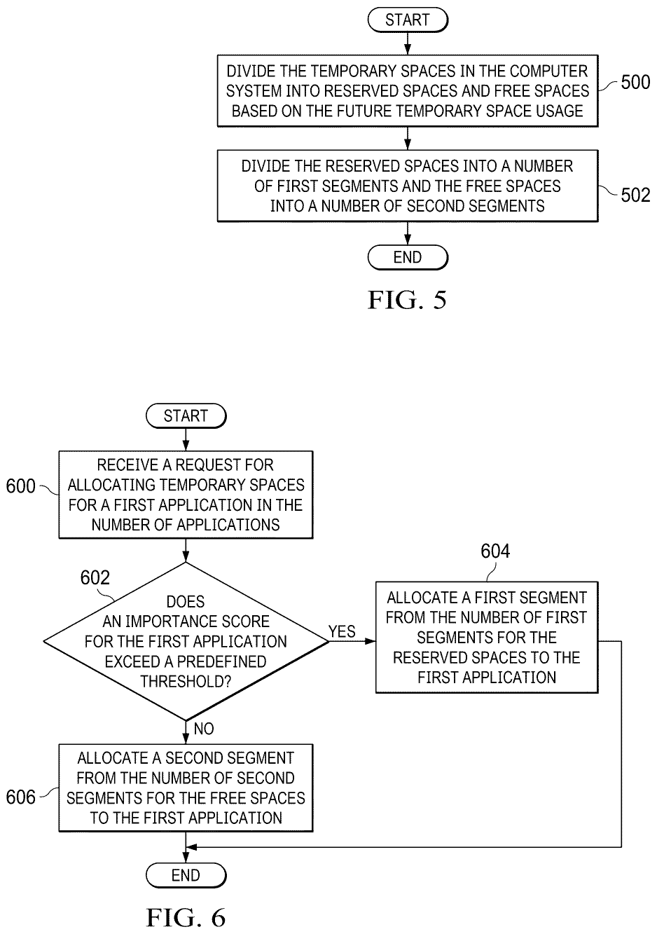

With reference now to FIG. 5, a flowchart illustrating a process for reserving temporary spaces is shown in accordance with an illustrative embodiment. The process in this flowchart is an example of an implementation for step 408 in FIG. 4.

The process begins by dividing the temporary spaces in the computer system into reserved spaces and free spaces based on the future temporary space usage (step 500). The process divides the reserved spaces into a number of first segments and the free spaces into a number of second segments (step 502). In step 502, each segment from the number of first segments and the number of second segments represents a temporary folder from the number of temporary folders. The process terminates thereafter.

With reference now to FIG. 6, a flowchart illustrating a process for allocating temporary spaces is shown in accordance with an illustrative embodiment. The process in this figure is an example of an additional step that can be performed with the steps in FIG. 5.

The process begins receiving a request for allocating temporary spaces for a first application in the number of applications (step 600). The process determines whether an importance score for the first application exceeds a predefined threshold (step 602). If the importance score for the first application exceeds the predefined threshold, the process allocates a first segment from the number of first segments for the reserved spaces to the first application (step 604). The process terminates thereafter.

With reference again to step 602, if the importance score for the first application does not exceed a predefined threshold, the process allocates a second segment from the number of second segments for the free spaces to the first application (step 606). The process terminates thereafter.

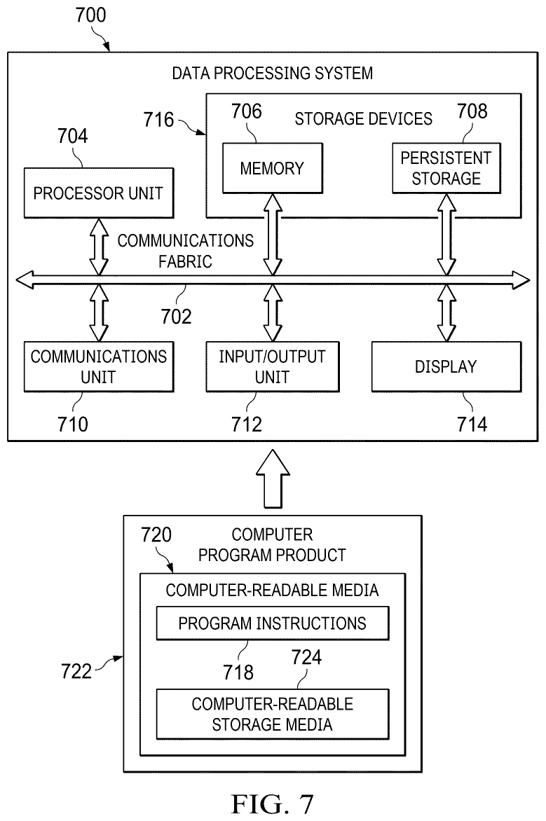

Turning now to FIG. 7, a block diagram of a data processing system is depicted in accordance with an illustrative embodiment. Data processing system 700 can be used to implement computers and computing devices in computing environment 100 in FIG. 1. Data processing system 700 can also be used to implement computer system 204 in FIG. 2. In this illustrative example, data processing system 700 includes communications framework 702, which provides communications between processor unit 704, memory 706, persistent storage 708, communications unit 710, input/output (I/O) unit 712, and display 714. In this example, communications framework 702 takes the form of a bus system.

Processor unit 704 serves to execute instructions for software that can be loaded into memory 706. Processor unit 704 includes one or more processors. For example, processor unit 704 can be selected from at least one of a multicore processor, a central processing unit (CPU), a graphics processing unit (GPU), a physics processing unit (PPU), a digital signal processor (DSP), a network processor, or some other suitable type of processor. Further, processor unit 704 can be implemented using one or more heterogeneous processor systems in which a main processor is present with secondary processors on a single chip. As another illustrative example, processor unit 704 can be a symmetric multi-processor system containing multiple processors of the same type on a single chip.

Memory 706 and persistent storage 708 are examples of storage devices 716. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 716 may also be referred to as computer-readable storage devices in these illustrative examples. Memory 706, in these examples, can be, for example, a random-access memory or any other suitable volatile or non-volatile storage device. Persistent storage 708 may take various forms, depending on the particular implementation.

For example, persistent storage 708 may contain one or more components or devices. For example, persistent storage 708 can be a hard drive, a solid-state drive (SSD), a flash memory, a rewritable optical disk, a rewritable magnetic tape, or some combination of the above. The media used by persistent storage 708 also can be removable. For example, a removable hard drive can be used for persistent storage 708.

Communications unit 710, in these illustrative examples, provides for communications with other data processing systems or devices. In these illustrative examples, communications unit 710 is a network interface card.

Input/output unit 712 allows for input and output of data with other devices that can be connected to data processing system 700. For example, input/output unit 712 may provide a connection for user input through at least one of a keyboard, a mouse, or some other suitable input device. Further, input/output unit 712 may send output to a printer. Display 714 provides a mechanism to display information to a user.

Instructions for at least one of the operating system, applications, or programs can be located in storage devices 716, which are in communication with processor unit 704 through communications framework 702. The processes of the different embodiments can be performed by processor unit 704 using computer-implemented instructions, which may be located in a memory, such as memory 706.

These instructions are referred to as program instructions, computer usable program instructions, or computer-readable program instructions that can be read and executed by a processor in processor unit 704. The program instructions in the different embodiments can be embodied on different physical or computer-readable storage media, such as memory 706 or persistent storage 708.

Program instructions 718 are located in a functional form on computer-readable media 720 that is selectively removable and can be loaded onto or transferred to data processing system 700 for execution by processor unit 704. Program instructions 718 and computer-readable media 720 form computer program product 722 in these illustrative examples. In the illustrative example, computer-readable media 720 is computer-readable storage media 724.

Computer-readable storage media 724 is a physical or tangible storage device used to store program instructions 718 rather than a medium that propagates or transmits program instructions 718. Computer-readable storage media 724, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 718 can be transferred to data processing system 700 using a computer-readable signal media. The computer-readable signal media are signals and can be, for example, a propagated data signal containing program instructions 718. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 720” can be singular or plural. For example, program instructions 718 can be located in computer-readable media 720 in the form of a single storage device or system. In another example, program instructions 718 can be located in computer-readable media 720 that is distributed in multiple data processing systems. In other words, some instructions in program instructions 718 can be located in one data processing system while other instructions in program instructions 718 can be located in one data processing system. For example, a portion of program instructions 718 can be located in computer-readable media 720 in a server computer while another portion of program instructions 718 can be located in computer-readable media 720 located in a set of client computers.

The different components illustrated for data processing system 700 are not meant to provide architectural limitations to the manner in which different embodiments can be implemented. In some illustrative examples, one or more of the components may be incorporated in or otherwise form a portion of another component. For example, memory 706, or portions thereof, may be incorporated in processor unit 704 in some illustrative examples. The different illustrative embodiments can be implemented in a data processing system including components in addition to or in place of those illustrated for data processing system 700. Other components shown in FIG. 7 can be varied from the illustrative examples shown. The different embodiments can be implemented using any hardware device or system capable of running program instructions 718.

Thus, illustrative embodiments of the present disclosure provide a computer-implemented method, computer system, and computer program product for managing containers. The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

1. A computer implemented method for managing temporary spaces in a computer system, the computer implemented method comprising:
analyzing, by a processor set, historical data for a number of applications to determine a temporary space usage for the number of applications;
assigning, by the processor set, labels to a number of temporary folders within the computer system, wherein the labels for the number of temporary folders are determined based on attributes associated with the number of applications;
training, by the processor set, a number of machine learning models based on the temporary space usage and information associated with the number of temporary folders;
determining, by the processor set, future temporary space usage for the number of applications using the machine learning models; and
reserving, by the processor set, a portion of the temporary spaces as reserved spaces in the computer system based on the future temporary space usage, wherein the temporary spaces are divided into free spaces and the reserved spaces, and wherein the free spaces and the reserved spaces are governed using different allocation policies.

2. The computer implemented method of claim 1, wherein the reserving, by the processor set, the portion of the temporary spaces as the reserved spaces in the computer system based on the future temporary space usage comprises:
dividing, by the processor set, the temporary spaces in the computer system into reserved spaces and free spaces based on the future temporary space usage; and
dividing, by the processor set, the reserved spaces into a number of first segments and the free spaces into a number of second segments, wherein each segment from the number of first segments and the number of second segments represents a temporary folder from the number of temporary folders.

3. The computer implemented method of claim 2, further comprising:
receiving, by the processor set, a request for allocating temporary spaces for a first application in the number of applications;
determining, by the processor set, whether an importance score for the first application exceeds a predefined threshold; and
in response to determining that the importance score for the first application exceeds a predefined threshold, allocating, by the processor set, a first segment from the number of first segments for the reserved spaces to the first application.

4. The computer implemented method of claim 3, further comprising:
in response to determining that the importance score for the first application does not exceed a predefined threshold, allocating, by the processor set, a second segment from the number of second segments for the free spaces to the first application.

5. The computer implemented method of claim 4, wherein the second segment from the number of second segments is determined by matching attributes for the first application to labels for each temporary folder represented by a segment from the number of second segments.

6. The computer implemented method of claim 3, wherein temporary spaces requested by the first application are allocated for a period of time based on life cycle of the first application.

7. The computer implemented method of claim 1, wherein the labels for the number of temporary folders comprise sizes of temporary spaces, identifiers for the number of applications, location of temporary spaces, and lifecycles for the number of applications.

8. A computer system for managing temporary spaces in a computer system, comprising:
a processor set;
a set of one or more computer-readable storage media; and
program instructions stored on the set of one or more storage media to cause the processor set to perform operations comprising:
analyzing historical data for a number of applications to determine a temporary space usage for the number of applications;
assigning labels to a number of temporary folders within the computer system, wherein the labels for the number of temporary folders are determined based on attributes associated with the number of applications;
training a number of machine learning models based on the temporary space usage and information associated with the number of temporary folders;
determining future temporary space usage for the number of applications using the machine learning models; and
reserving a portion of the temporary spaces as reserved spaces in the computer system based on the future temporary space usage, wherein the temporary spaces are divided into free spaces and the reserved spaces, and wherein the free spaces and the reserved spaces are governed using different allocation policies.

9. The computer system of claim 8, wherein the reserving the portion of the temporary spaces as the reserved spaces in the computer system based on the future temporary space usage comprises:
dividing the temporary spaces in the computer system into reserved spaces and free spaces based on the future temporary space usage; and
dividing the reserved spaces into a number of first segments and the free spaces into a number of second segments, wherein each segment from the number of first segments and the number of second segments represents a temporary folder from the number of temporary folders.

10. The computer system of claim 9, wherein the operations further comprise:
receiving a request for allocating temporary spaces for a first application in the number of applications;
determining whether an importance score for the first application exceeds a predefined threshold; and
in response to determining that the importance score for the first application exceeds a predefined threshold, allocating a first segment from the number of first segments for the reserved spaces to the first application.

11. The computer system of claim 10, wherein the operations further comprise:
in response to determining that the importance score for the first application does not exceed a predefined threshold, allocating a second segment from the number of second segments for the free spaces to the first application.

12. The computer system of claim 11, wherein the second segment from the number of second segments is determined by matching attributes for the first application to labels for each temporary folder represented by a segment from the number of second segments.

13. The computer system of claim 10, wherein temporary spaces requested by the first application are allocated for a period of time based on life cycle of the first application.

14. The computer system of claim 8, wherein the labels for the number of temporary folders comprise sizes of temporary spaces, identifiers for the number of applications, location of temporary spaces, and lifecycles for the number of applications.

15. A computer program product for managing temporary spaces in a computer system, comprising:
a set of one or more computer-readable storage media;
program instructions stored in the set of one or more computer-readable storage media to perform operations comprising:
analyzing, by a processor set, historical data for a number of applications to determine a temporary space usage for the number of applications;
assigning, by the processor set, labels to a number of temporary folders within the computer system, wherein the labels for the number of temporary folders are determined based on attributes associated with the number of applications;
training, by the processor set, a number of machine learning models based on the temporary space usage and information associated with the number of temporary folders;
determining, by the processor set, future temporary space usage for the number of applications using the machine learning models; and
reserving, by the processor set, a portion of the temporary spaces as reserved spaces in the computer system based on the future temporary space usage, wherein the temporary spaces are divided into free spaces and the reserved spaces, and wherein the free spaces and the reserved spaces are governed using different allocation policies.

16. The computer program product of claim 15, wherein the reserving, by the processor set, the portion of the temporary spaces as the reserved spaces in the computer system based on the future temporary space usage comprises:
dividing, by the processor set, the temporary spaces in the computer system into reserved spaces and free spaces based on the future temporary space usage; and
dividing, by the processor set, the reserved spaces into a number of first segments and the free spaces into a number of second segments, wherein each segment from the number of first segments and the number of second segments represents a temporary folder from the number of temporary folders.

17. The computer program product of claim 16, wherein the operations further comprise:
receiving, by the processor set, a request for allocating temporary spaces for a first application in the number of applications;
determining, by the processor set, whether an importance score for the first application exceeds a predefined threshold; and
in response to determining that the importance score for the first application exceeds a predefined threshold, allocating, by the processor set, a first segment from the number of first segments for the reserved spaces to the first application.

18. The computer program product of claim 17, wherein the operations further comprise:
in response to determining that the importance score for the first application does not exceed a predefined threshold, allocating, by the processor set, a second segment from the number of second segments for the free spaces to the first application.

19. The computer program product of claim 18, wherein the second segment from the number of second segments is determined by matching attributes for the first application to labels for each temporary folder represented by a segment from the number of second segments.

20. The computer program product of claim 17, wherein temporary spaces requested by the first application are allocated for a period of time based on life cycle of the first application.
